(19) United States
(12) Patent Application Publication
(10) Pub. No.: US 2007/0272740 A1
(43) Pub. Date: Nov. 29, 2007

(54) ELECTRONIC RECEIPT METHOD AND APPARATUS

(75) Inventor: Raul G. Palacios, Littleton, CO (US)

Correspondence Address: SHERIDAN ROSS PC, 1560 BROADWAY, SUITE 1200, DENVER, CO, 80202, US

(73) Assignee: Cognitive Solutions, Inc., Golden, CO (US)

(21) Appl. No.: 11/753,080

(22) Filed: May 24, 2007

Related U.S. Application Data
(60) Provisional application No. 60/803,324, filed on May 26, 2006.

(51) Int. Cl. G06K 5/00

(52) U.S. Cl. 235/380

(57) ABSTRACT

The present invention provides for the delivery of an electronic receipt. A delivery address is read from a storage medium carried by a consumer by a complimentary reader. The reader provides the delivery address for association with information related to the terms of a transaction entered into by the consumer. The information related to the terms of the transaction are then sent to the delivery address, thereby providing an electronic receipt. The delivery address in machine readable form is all the information needed to adequately address the electronic receipt for delivery. Accordingly, reference to an external database or other information in order to obtain such address information is not required.

### CROSS-REFERENCE TO RELATED APPLICATIONS

This application claims the benefit of U.S. Provisional Application No. 60/803,324, filed May 26, 2006, the entire disclosure of which is hereby incorporated herein by reference.

### FIELD

The disclosed invention is related to the delivery of electronic receipts associated with a transaction.

### BACKGROUND

Transactions are commonly evidenced by a receipt that is generated immediately following completion of the transaction. For example, a purchase may result in a printed sales receipt generated by a cashier operated terminal. As a further example, a printed receipt may be generated in connection with a self-service transaction, such as a “pay at the pump” purchase of gasoline, or a withdrawal of funds from an automated teller machine (ATM).

Although receipts can be helpful if a dispute related to a transaction arises, the need to collect and carry a physical receipt is considered a nuisance by many consumers. As a result, many consumers decline the opportunity to have a physical receipt provided to them, which can leave the consumer with no evidence of the terms of a transaction. Furthermore, even if a consumer accepts a physical receipt, many consumers neglect to reconcile accounts that are affected by the transaction, or to otherwise enter the transaction in their records.

Many transactions are performed using settlement or payment terms other than cash. Therefore, evidence of such transactions may appear in records that are available to a consumer separately from a transaction receipt, such as credit card statements. However, such records often fail to include details of the transaction, such as an identification of an item or items purchased as part of the transaction. A receipt comprising a record of a transaction can be delivered to a consumer based on consumer account information. However, delivering a receipt to a consumer based on a consumer account number or other information requires that the account be matched to a communication address associated with the consumer. This typically requires a search of a database for the address information, and is prone to errors, for example due to infrequent updating of the database records or incorrect entry of data. Also, delivering a receipt to an address derived from account information is generally impossible in connection with cash transactions where information identifying the consumer is not provided.

### SUMMARY

In accordance with embodiments of the present invention, a receipt is delivered electronically to a consumer address, such as an email address, that is provided to a system directly, rather than derived from other information. As used herein, the term “receipt” refers to a record of at least some terms or circumstances of a transaction. The term “consumer” as used herein refers to a party to a transaction. An identifier comprising address information may be provided by the consumer manually or in connection with automated techniques. All example of manual entry of an address comprises keying the address into a terminal associated with or connected to a receipt processing system as part of or following a transaction. Examples of automated entry of an address include presenting a bar code, a card with a magnetic stripe, a computer readable chip, or a radio frequency identification device (RFID) containing the delivery address to a suitable reader associated with or connected to a receipt processing system. Whether entered into the receipt processing system manually or using an automated device, an address that can be used to deliver a receipt to a consumer is provided to the receipt processing system.

Because embodiments of the present invention provide a communication address to a receipt processing system directly, the consumer need not be registered with some entity associated with a transaction in order to have a receipt delivered to an appropriate address. In addition, no lookup of address information in database or other records is required. Instead, the address is received directly from a consumer input, or is received as a machine-readable code.

Delivery of an electronic receipt in accordance with embodiments of the present invention may comprise delivering an email to a provided address comprising a consumer email address. The information comprising the electronic receipt may be provided by the text of the email, and/or by a separate attachment. Furthermore, the email and/or the attachment may be in a format that can be read by a conventional database engine or application program. For example, the format may be one that can be read by a personal finance program. In accordance with other embodiments of the present invention, the receipt can be in a proprietary format, for example for election or internal business processes. In accordance with still other embodiments of the present invention, the receipt can be delivered as an image file.

### BRIEF DESCRIPTION OF THE DRAWINGS

FIG. 1 is schematic depiction of the delivery of electronic receipts in accordance with embodiments of the present invention;

FIG. 2 is a block diagram of components of a receipt processing system in accordance with embodiments of the present invention; and

FIG. 3 is a flowchart of a process for delivering electronic receipts in accordance with embodiments of the present invention.

### DETAILED DESCRIPTION

Embodiments of the present invention provide for the delivery of electronic receipts evidencing a transaction. In particular, embodiments of the present invention provide for delivering a receipt to an address presented by a user or consumer who is party to or otherwise involved in a transaction contemporaneously with or immediately following the transaction. Furthermore, because the delivery address itself is presented, pre-registration of a delivery address and/or searching a database for address information is avoided.

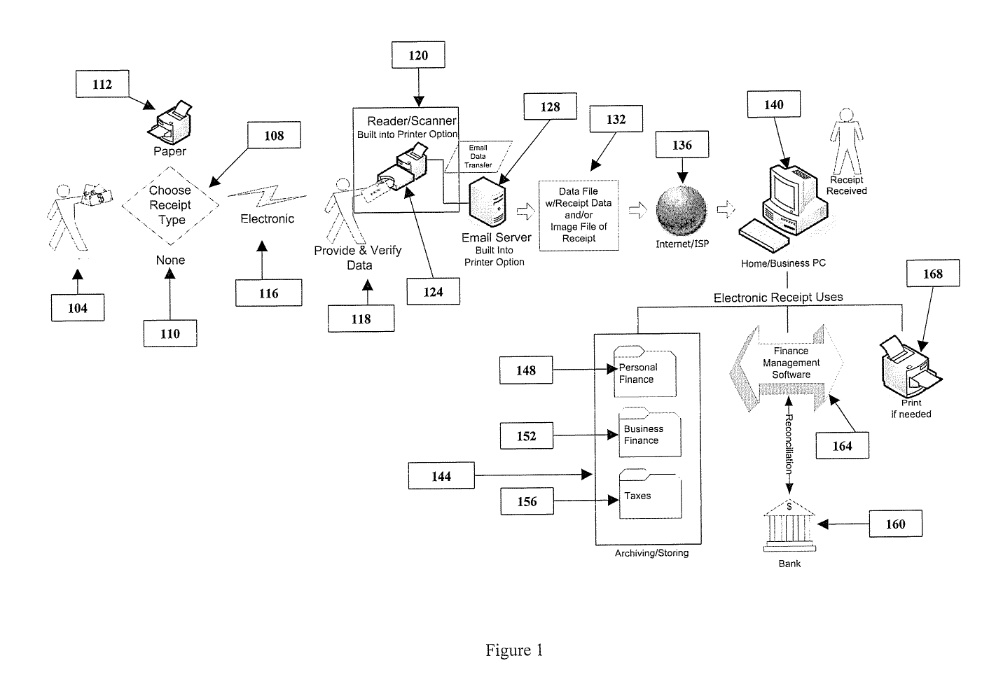

With reference to FIG. 1, a process for delivering electronic receipts in accordance with embodiments of the present invention is depicted. Initially, a consumer or purchaser 104 completes or participates in a transaction, such as the purchase of a good or service. The consumer 104 then chooses a receipt type 108. The choices available to the consumer 104 can include receiving no receipt at all 110, receiving a paper receipt 112, and/or receiving an electronic receipt 116 as described herein.

If the consumer 104 chooses to receive an electronic receipt 116, the consumer 104 provides or presents data 118 comprising a delivery address to a receipt processing system 120. The delivery address may be provided by the consumer 104 manually, for example by entering the delivery address into the receipt processing system 120 using an associated keyboard or other consumer input. As an alternative, and as shown in FIG. 1, the delivery address may be stored on a storage medium or means for storing a delivery address carried by the consumer and may be entered into the system by the consumer 104 through an automated procedure. The automated procedure can comprise, for example, presenting a storage medium comprising a card or tag carrying a machine readable version of the delivery address to an appropriate reader or scanner 124 associated with the receipt processing system 120. As examples, and without limiting the invention, the storage medium may comprise a barcode, magnetic stripe, or radio frequency identification chip. In accordance with embodiments of the present invention, the card or tag can carry additional information, such as consumer account information. Accordingly, the card or tag can comprise a consumer credit or debit card with a stored delivery address. Whether entered manually or presented in a machine readable form, the address is provided in a complete form such that it can be used by the receipt processing system to deliver the electronic receipt 116, without requiring the retrieval of additional or different address information by the receipt processing system 120. As an example, the delivery address may comprise an email address.

The receipt processing system 120 associates information related to or evidencing the transaction with the delivery address provided by the consumer for that transaction, and sends the resulting electronic receipt 116 to the delivery address. In accordance with embodiments of the present invention, the electronic receipt 116 is sent as an email. Accordingly, the electronic receipt 116 with the associated delivery address may be provided to an email server 128, and transmitted as an email message and/or an attachment 132 across a network 136 such as the Internet to the indicated address. In accordance with further embodiments of the present invention, the delivery address may comprise a network address, such as an Internet Protocol (IP) address. Moreover, the electronic receipt 116 may comprise data file (such as a file that can be read and used by an application), an image file (such as a .pdf), or a data file and an image file.

As can be appreciated by one of skill in the art, the electronic receipt 116 can then be stored and/or processed using a computer or other device 140 associated with or capable of retrieving information from the delivery address. In particular, the consumer may store the electronic receipt 116 and can use it in connection with a consumer application program 144. Examples of consumer application programs 144 include personal finance applications 148, business finance applications 152, and tax preparation applications 156. Accordingly, the information comprising the electronic receipt may include information that can be read by and incorporated into an application program 144. The electronic receipt can also be used in connection with the reconciliation of accounts, for example a bank account 160. Reconciliation may be performed in connection with a consumer application program 144, or a remotely accessed program 164, such as a web-based program provided through a bank website. A printer 168 associated with the computer 140 may be used to create a hard copy of the receipt or information included.

A receipt processing system 120 in accordance with embodiments of the present invention may comprise a computing device capable of placing information related to an event or other transaction into an electronic message and/or collecting a delivery address from a consumer associated with the transaction. Accordingly, examples of a receipt processing system 120 include a cash register, automatic teller machine, automated kiosk, self-service gasoline pump or general purpose computer.

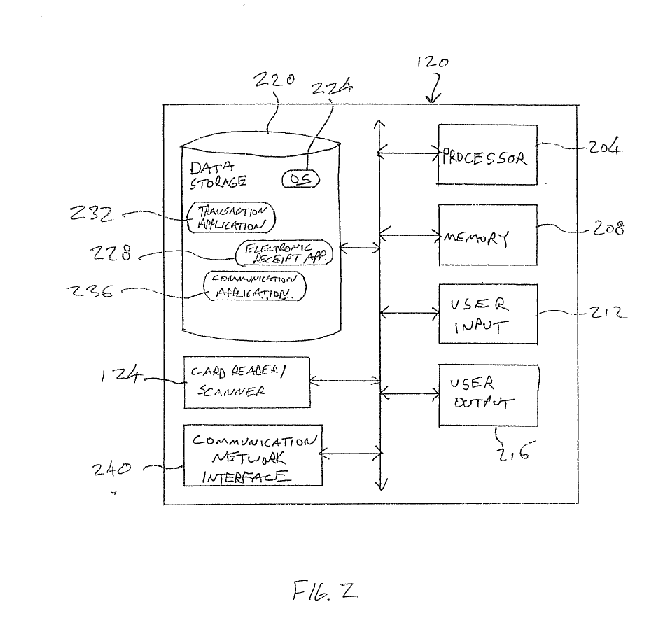

With reference to FIG. 2, components of a receipt processing system 120 in accordance with embodiments of the present invention are illustrated. The components may include a processor 204 capable of executing program instructions or code. Accordingly, the processor 204 may include any general purpose programmable processor or controller for executing application programming. Alternatively, the processor 204 may comprise a specially configured application specific integrated circuit (ASIC). The processor 204 generally functions to run programming instructions or code implementing various functions performed by the receipt processing system 120.

A receipt processing system 120 may additionally include memory 208 for use in connection with the execution of programming by the processor 204, and for the temporary or long term storage of data or program instructions. The memory 208 may comprise solid state memory, such as DRAM and SDRAM. Where the processor 204 comprises a controller, the memory 208 may be integral to the processor 204.

In addition, various user input devices 212 and user output devices 216 may be provided. Examples of input devices 212 include a microphone, keyboard, numeric keypad and pointing device combined with a screen or other position encoder. In general, an input device 212 may be used by a consumer to enter commands or data related to a transaction. Alternatively or in addition, an input device 212 can be used by a consumer to enter a delivery address to be used in connection with the delivery of an electronic receipt related to a transaction. Examples of user output devices 216 include a printer, speaker, alpha-numeric display or a graphic display or monitor.

A receipt processing system 120 may also include data storage 220 for the storage of application programming and/or data. For example, operating system software 224 may be stored in data storage 220. In addition, an electronic receipt application or means for associating information related to the terms of a transaction with a delivery address 228 can be stored in data storage 220. Examples of other applications that can be stored in data storage 220 include a transaction application or means for memorializing the terms of a transaction 232, and a communication application 236. The electronic receipt application 228 can provide functions related to the collection of receipt information from a transaction application 232 or some other application, and the collection of address data information from a consumer to be used to deliver an electronic receipt to the consumer as a file and/or an image file. The transaction application 232 generally comprises an application to create and/or collect information related to a transaction. Accordingly, examples of a transaction application 232 include a cash register application, self-service gas pump or other self service device application, automatic teller machine operating instructions, an application for obtaining transaction information from another system or device. The communication application 236 can comprise a program capable of composing messages and at least initiating the delivery of such messages to an electronic address. Accordingly, examples of a communication application 236 include an email program or a text messaging program. Although examples of separate electronic receipt 228, transaction 232, and communication 236 applications have been described, functions of some or all of these applications can be combined into a lesser number of applications. In addition, although described as applications that comprise programming stored in data storage, other arrangements are possible. For instance, some or all of the functions described in connection with the applications 228-236 can be performed in connection with hard wired logic circuits or the execution of firmware.

A receipt processing system 120 may additionally include a card reader and/or a scanner 124. In general, a card reader or scanner 124 is operable to read a delivery address from a card, chip or other item presented by a consumer in connection with a transaction. Accordingly, the card reader or scanner 124 may comprise a bar code reader, optical scanner, magnetic card reader, radio frequency identification device scanner or any other device capable of reading a delivery address carried by a consumer in a machine readable format. Moreover, the card reader or scanner may comprise a means for reading a delivery address.

A receipt processing system 120 also generally includes a communication network interface 240 for interconnecting the receipt processing system 120 to a communication bus, link or network, such as the Internet 136. The communication network interface 240 may operate in connection with one or more communication protocols. For example, the communication interface 240 may support communications according to a wired or wireless Ethernet protocol.

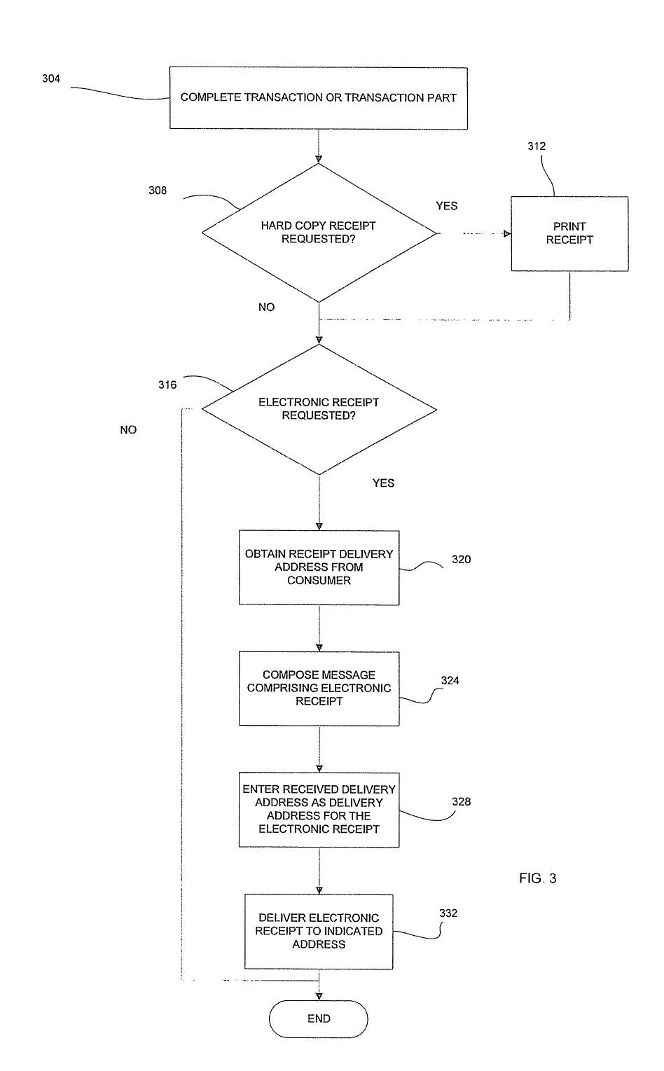

With reference to FIG. 3 aspects of the operation of a receipt processing system 120 in accordance with embodiments of the present invention are illustrated. Initially, a transaction or transaction part is completed between a consumer (a first party to the transaction) and a second party to the transaction (step 304). Examples of a transaction include a purchase of gasoline from a self-serve gasoline pump or a purchase of food from a grocery store. An example of a transaction part is dropping clothes at a drycleaner for pick-up at a later date. Many other examples of transactions or transaction parts are possible, and the examples given above are not intended to be limiting, but instead are provided for illustration purposes.

At step 308, a determination is made as to whether a hardcopy receipt 112 of the transaction is requested by the consumer who is party to the transaction. If a hardcopy receipt 112 is requested, it may be printed or otherwise created (step 312) and provided to the consumer.

A determination may then be made as to whether an electronic receipt 116 has been requested by the consumer (step 316). If an electronic receipt 116 has been requested, a delivery address is obtained from the consumer (step 320). The consumer 104 may provide the delivery address to the receipt processing system 120 in a number of ways. For example, the consumer 104 may manually enter a delivery address using a keyboard or other user input 212 associated or in communication with the receipt processing system 120. The consumer 104 may also provide the delivery address using an automated or partially automated procedure. For instance, an item carried by the consumer 104, such as a card, containing a machine-readable version of the delivery address may be presented. Examples of machine readable versions of the delivery address include: bar codes, optically or magnetically read alpha-numeric characters, magnetic stripes, and RFID chips. Obtaining a delivery address using a process incorporating an item carried by a consumer 104 comprising a machine-readable version of the delivery address (i.e. an item having a machine-readable code) may be partially automated in that it may require that the consumer present the item to an appropriate reader or scanner 124. The process for obtaining a delivery address may be fully automated if, for example, the machine-readable code for presenting the delivery address on an item carried by the consumer can be read by a reader or scanner 124 without requiring that the consumer take specific action to present the item to the reader or scanner 124, for example by waving a card carrying a bar code in front of a bar code scanner or by sliding a card having a magnetic stripe through a magnetic card reader. In accordance with embodiments of the present invention, the machine-readable code presenting the delivery address may be stored with consumer payment or account information, such as a credit card number and expiration date, and delivered at the same time such account information is delivered to the second party. For example, by swiping a credit card with both the delivery address and credit card information encoded on a magnetic stripe through a card reader 124, the consumer can simultaneously provide the delivery address and payment information to the second party. Accordingly, the delivery address and consumer payment information can be provided during a single read operation, such as through a single swipe of a magnetic stripe on a card through the card reader.

Although the delivery address is in machine-readable form or code, no conversion other than a possible translation is required in order to use the provided address to deliver an electronic receipt to the specified address. For example, a delivery address comprising an email address may be provided to the receipt processing system 120 as a machine readable binary code, and thus may require only a translation from the binary code to alpha-numeric characters in order to be used to deliver an electronic receipt 116 to the specified address or to signify the delivery address in a form that is readily comprehendible by a human. Accordingly, there is no need to perform a search of a customer or other database in order to associate the consumer who is a party to the transaction with a delivery address. Instead, the provided address may be used directly.

At step 324, the receipt processing system 120 composes a message comprising the requested electronic receipt 116. Composing the message may include creating an email or text message containing details related to the transaction that is addressed to the delivery address obtained from the consumer. The message may also include graphical elements. For example, the message may include an image that mimics a hard-copy receipt for the transaction. Such an image may be provided as an image file. Composing the message may also include appending a file to an email or text message addressed to the delivery address provided by the consumer, or otherwise associating a file with the delivery address obtained from the consumer. The electronic receipt may then be delivered to the delivery address 328. After delivering the electronic receipt, or if the consumer chooses not to receive an electronic receipt, the process may end.

Embodiments of the present invention are capable of providing an electronic proof of purchase or transaction, or other type of receipt in an accurate, simple, and standardized manner via electronic mail or other electronic delivery methods. Standards for automatically identifying and reading information, such as barcode, magnetic stripe, chip and PIN, optical character recognition, keyboard/touchscreen and RFID can be used to provide the delivery address information to the receipt processing system. Furthermore, because automated processes can be used, it is easy for a consumer to provide several email addresses that can each serve as recipient addresses for an electronic receipt. Where multiple addresses are provided through an automated means, the user may be given the opportunity to select one or more of the addresses for delivery of the electronic receipt.

Because an electronic receipt is provided, it can include data that can be read or processed by various application programs. Accordingly, embodiments of the present invention can facilitate consumer record keeping.

The foregoing discussion of the invention has been presented for purposes of illustration and description. Further, the description is not intended to limit the invention to the form disclosed herein. Consequently, variations and modifications commensurate with the above teachings within the skill or knowledge of the relevant art are within the scope of the present invention. The embodiments described hereinabove are further intended to explain the best mode presently known of practicing the invention and to enable others skilled in the art to utilize the invention in such or in other embodiments and with the various modifications required by the particular application or use of the invention. It is intended that the appended claims be construed to include alternative embodiments to the extent permitted by the prior art.

What is claimed is:

1. A method for providing an electronic receipt, comprising:
a first consumer completing a transaction or transaction part;
as part of completing a transaction or transaction part, the first consumer providing an identifier, the identifier including:
a delivery address associated with the first consumer, wherein presenting an identifier comprises providing the delivery address as an address stored on a machine readable storage medium;
delivering an electronic receipt associated with the transaction to the delivery address provided by the user.

2. The method of claim 1, wherein the machine readable storage medium also contains consumer payment information, and wherein the delivery address and the consumer payment information are read during a single read operation.

3. The method of claim 1, wherein delivering an electronic receipt includes delivering a data file to the delivery address.

4. The method of claim 1, wherein delivering an electronic receipt includes delivering an image file to the delivery address.

5. The method of claim 1, wherein said delivering an electronic receipt includes attaching a file comprising a receipt to an email that is addressed to the delivery address.

6. The method of claim 1, wherein the electronic receipt comprises an email, and wherein the provided delivery address is the delivery address of the email.

7. The method of claim 1, wherein the electronic receipt is delivered to the user using the delivery address provided by the user without requiring that a look-up operation be performed.

8. The method of claim 1, further comprising:
accessing the receipt delivered to the address; and
printing a copy of information included in the receipt.

9. The method of claim 1, further comprising:
accessing the receipt delivered to the address; and
extracting financial data included in the receipt.

10. The method of claim 9, further comprising:
adjusting an account balance based on the financial data extracted from the receipt.

11. The method of claim 1, wherein the machine readable identifier includes at least one of a barcode, magnetic stripe, chip and PIN, optically recognizable text or code, and RFID.

12. A receipt processing system, comprising:
a storage medium, wherein a delivery address related to a first consumer is stored in the storage medium in a machine readable form;
a reader, wherein the reader is operable to read the machine readable information including the delivery address from the storage medium;
a transaction application, wherein information related to a transaction entered into by the first consumer is generated;
an electronic receipt application, wherein the information related to the transaction entered into by the first consumer generated by the transaction application is provided to the electronic receipt application, wherein the electronic receipt application is operable to generate an electronic receipt using the information related to the transaction and to address the electronic receipt using the delivery address read from the storage medium by the reader.

13. The system of claim 12, further comprising:
a user input, wherein the first consumer enters a selection to receive the electronic receipt at the delivery address through the user input.

14. The system of claim 12, wherein the storage medium is provided as a credit card or a debit card.

15. The system of claim 12, wherein the storage medium is provided as an identification card.

16. The system of claim 12, wherein the electronic receipt application applies the electronic receipt to an email message without performing a look-up operation.

17. The system of claim 16, wherein the electronic receipt comprises an image file attached to the email.

18. A system for providing a consumer with an electronic receipt as evidence of a transaction, comprising:
means for memorializing the terms of a transaction;
means for storing a delivery address associated with a consumer, wherein the means for storing are portable and can be carried by the consumer;
means for reading the delivery address associated with a consumer from the means for storing;
means for associating information related to the terms of a transaction associated with the consumer with the address and for initiating delivery of the information related to the terms of the transaction to the consumer.

19. The system of claim 18, wherein the means for storing a delivery address associated with a consumer also comprise means for storing account information associated with the consumer.

20. The system of claim 18, wherein the delivery address comprises an email address.
